(19) United States
(12) Patent Application Publication
(10) Pub. No.: US 2020/0153043 A1
(43) Pub. Date: May 14, 2020

(54) LIQUID ELECTROLYTE, FLUORIDE ION BATTERY, AND METHOD FOR PRODUCING LIQUID ELECTROLYTE

(71) Applicants: Hirofumi NAKAMOTO, Susono-shi (JP); Reiji TAKEKAWA, Sendai-shi (JP); Junichi KAWAMURA, Sendai-shi (JP)

(72) Inventors: Hirofumi NAKAMOTO, Susono-shi (JP); Reiji TAKEKAWA, Sendai-shi (JP); Junichi KAWAMURA, Sendai-shi (JP)

(73) Assignees: TOYOTA JIDOSHA KABUSHIKI KAISHA, Toyota-shi (JP); TOHOKU UNIVERSITY, Sendai-shi (JP)

(21) Appl. No.: 16/597,946

(22) Filed: Oct. 10, 2019

(30) Foreign Application Priority Data
Nov. 12, 2018 (JP) 2018-212383

(51) Int. Cl. H01M 10/0567; H01M 10/0568; H01M 10/0569

(52) U.S. Cl. CPC H01M 10/0567; H01M 2300/0025; H01M 10/0569; H01M 10/0568

(57) ABSTRACT

A main object of the present disclosure is to provide a liquid electrolyte in which concentration of active fluoride ion is high even when a cesium fluoride (CsF) is included therein. The present disclosure achieves the object by providing a liquid electrolyte to be used in a fluoride ion battery, the liquid electrolyte comprising: a cesium fluoride and a solvent; and an amount of moisture is 50 ppm or more and 1100 ppm or less.

### TECHNICAL FIELD

The present disclosure relates to a liquid electrolyte, a fluoride ion battery, and a method for producing the liquid electrolyte.

### BACKGROUND ART

As high-voltage and high-energy density batteries, for example, Li ion batteries are known. The Li ion battery is a cation-based battery utilizing the reaction of Li ions with a cathode active material and the reaction of Li ions with an anode active material. Meanwhile, as anion-based batteries, fluoride ion batteries utilizing the reaction of fluoride ions (fluoride anions) are known.

For example, Patent Literatures 1 and 2 disclose fluoride ion batteries using a liquid electrolyte containing a cesium fluoride (CsF). Meanwhile, Patent Literature 3 discloses a solid electrolyte material containing CsF. Also, Patent Literature 4 discloses CsF as an example of a metal salt used in a liquid electrolyte.

### CITATION LIST

### Patent Literatures

Patent Literature 1: Japanese Patent Application Laid-Open (JP-A) No. 2016-062821

Patent Literature 2: JP-A No. 2016-197543

Patent Literature JP-A No. 2018-077992

Patent Literature 4: JP-A No. 2017-216048

### SUMMARY OF DISCLOSURE

### Technical Problem

In a liquid electrolyte containing cesium fluoride (CsF), the concentration of active fluoride ion tends to be low. The present disclosure has been made in view of the above circumstances and a main object thereof is to provide a liquid electrolyte in which the concentration of active fluoride ion is high even when a cesium fluoride (CsF) is included therein.

### Solution to Problem

In order to achieve the object, the present disclosure provides a liquid electrolyte to be used in a fluoride ion battery, the liquid electrolyte comprising: a cesium fluoride and a solvent; and an amount of moisture is 50 ppm or more and 1100 ppm or less.

According to the present disclosure, the amount of moisture in the specific range allows the liquid electrolyte to have high concentration of active fluoride ion even when a cesium fluoride (CsF) is included therein,

In the disclosure, the amount of moisture may be 50 ppm or more and 900 ppm or less.

In the disclosure, the concentration of active fluoride ion at 25° C. may he 2.0 mM or more.

In the disclosure, the liquid electrolyte may further comprise an alkali metal amide salt.

In the disclosure, the liquid electrolyte may contain a glyme as the solvent.

The present disclosure also provides a fluoride ion battery comprising a cathode active material layer, an anode active material layer, and an electrolyte layer formed between the cathode active material layer and the anode active material layer; wherein the electrolyte layer contains the above described liquid electrolyte.

According to the present disclosure, usage of the above described liquid electrolyte allows a fluoride ion battery to have, for example, excellent capacity properties.

The present disclosure also provides a method for producing a liquid electrolyte to be used in a fluoride ion battery, the method comprising: a preparing step of preparing a precursor solution containing a cesium fluoride and a solvent; and a drying step of conducting a decompression drying treatment to the precursor solution under an inert atmosphere with a dew point of −90° C. or less to obtain the liquid electrolyte of which amount of moisture is 50 ppm or more and 1100 ppm or less.

In the present disclosure, the decompression drying treatment is conducted in an environment with extremely low dew point and the amount of moisture is adjusted to the specific range so as to obtain a liquid electrolyte in which the concentration of active fluoride ion is high.

### Advantageous Effects of Disclosure

The present disclosure exhibits an effect such that a liquid electrolyte having high concentration of active fluoride ion can be provided even when cesium fluoride (CsF) is included therein.

### BRIEF DESCRIPTION OF DRAWINGS

FIG. 1 is a schematic cross-sectional view illustrating an example of the fluoride ion battery in the present disclosure.

FIG. 2 is a flow chart showing an example of the method for producing the liquid electrolyte in the present disclosure

FIG. 3 is the result of a ¹⁹F-MNR measurement for a liquid electrolyte containing CsF.

FIG. 4 is the result of a ¹⁹F-MNR measurement for a liquid electrolyte not containing CsF.

FIG. 5 is the result of a ¹⁹-MNR measurement for a liquid electrolyte containing CsF.

FIG. 6 is a graph showing the relation between the amount of moisture and active F⁻.

### DESCRIPTION OF EMBODIMENTS

The liquid electrolyte, the fluoride ion battery, and the method for producing the liquid electrolyte in the present disclosure are hereinafter described in details.

A. Liquid Electrolyte

The liquid electrolyte in the present disclosure is a liquid electrolyte to be used in a fluoride ion battery, the liquid electrolyte contains a cesium fluoride and a solvent, wherein the amount of moisture is in the specific range.

According to the present disclosure, the amount of moisture in the specific range allows the liquid electrolyte to have high concentration of active fluoride ion even when a cesium fluoride (CsF) is included therein. When the concentration of active fluoride ion is high, the conductivity of fluoride ion in the liquid electrolyte improves and thus, the improvement of battery characteristics (such as capacity properties) may be achieved.

Here, when the cesium fluoride (CsF) is used as the fluoride salt (supporting electrolyte) of the liquid electrolyte, the amount of moisture in the liquid electrolyte easily increases. This is because the CsF easily reacts with the moisture in the atmosphere. Also, as described in Examples later, when the amount of moisture in the liquid electrolyte is large, the concentration of active fluoride ion easily decreases. This is presumably because the fluoride ion (F⁻) deactivated due to the moisture. To solve the problems, in the present disclosure, reducing the amount of moisture in the liquid electrolyte from the amount conventionally included allows the liquid electrolyte to have high concentration of active fluoride ion.

Meanwhile, the inventors of the present application have obtained a knowledge that the concentration of active fluoride ion also decreases when the amount of moisture in the liquid electrolyte is reduced too much. The reason therefor is not completely clear, but presumably because the fluoride ion (F⁻) is unstable and it is difficult to be separated from the CsF. Alternatively, it can be also considered that, for example, when a vacuum drying is conducted, there is a possibility the volatilization of the fluoride ion (F⁻) irreversibly occurs along with the volatilization of moisture. To solve the problem, in the present disclosure, the amount of moisture in the liquid electrolyte is set not too low so as to obtain the liquid electrolyte in which the concentration of active fluoride ion is high.

1. Cesium Fluoride

The liquid electrolyte in the present disclosure contains a cesium fluoride as a fluoride salt. As the fluoride salt, the liquid electrolyte may contain just the cesium fluoride, and may contain an additional fluoride ion. In the latter case, the liquid electrolyte preferably mainly contains the cesium fluoride as the fluoride salt. The proportion of the cesium fluoride in the entire fluoride salts is, for example, 70 weight % or more, may be 80 weight % or more, and may be 90 weight % or more. Incidentally, the fluoride salt refers to a compound of which anion is F⁻.

The concentration of the cesium fluoride in the liquid electrolyte is, for example, 0.1 mol/L or more, may be 0.3 mol/L or more, and may be 0.5 mol/L or more. Meanwhile, the concentration of the cesium fluoride is, for example, 6 mol/L or less, and may be 3 mol/L or less.

2. Solvent

The solvent in the present disclosure is a solvent that dissolves at least a part of the cesium fluoride. The solvent in the present disclosure may dissolve all the cesium fluoride, and may dissolve just a part of the cesium fluoride (undissolved portion may be present).

Examples of the solvent may include a cyclic carbonate such as ethylene carbonate (EC), fluoro ethylene carbonate (FEC), di-fluoro ethylene carbonate (DFEC), propylene carbonate (PC), and butylene carbonate (BC); a chain carbonate such as dimethyl carbonate (DMC), diethyl carbonate (DEC), and ethyl methyl carbonate (EMC); a chain ether such as diethyl ether, 1,2-dimethoxymethane and 1,3-dimethoxypropane; a cyclic ether such as tetrahydrofuran and 2-methyltetrahydrofuran; a cyclic sulfone such as sulfolane; a chain sulfone such as dimethylsulfoxide (DMSO); a cyclic ester such as γ-butyrolactone; a nitrile such as acetonitrile; and an arbitrary mixture of these.

Also, an additional example of the chain ether may be glyme. The glyme is a compound categorized as glycol ethers. Above all, it is preferable that the glyme is represented by the general formula: R¹—O (CH₂CH₂O)ₙ—R² (R¹ and R² are each independently a C4 or less alkyl group or a C4 or less fluoroalkyl group, and n is 2 or more and 10 or less).

In the general formula, R¹ and R² may be the same and may be different from each other. Also, the number of carbon atoms (C) of R¹ or R² is, for example, 4 or less, and may be any one of 4, 3, 2, and 1. Examples of the C4 or less alkyl group may include a methyl group, an ethyl group, a propyl group, an isopropyl group, a butyl group, a sec-butyl group, an isobutyl group, and a tert-butyl group. Also, the fluoroalkyl group is a group in which a part or whole hydrogen in the alkyl group is substituted with a fluorine. Also, in the general formula, “n” is usually 2 or more, and may be 3 or more. Meanwhile, “n” is, for example, 10 or less, may be 8 or less, and may be 5 or less.

Specific examples of the glyme may include diethylene glycol diethyl ether (G2), triethylene glycol dimethyl ether (G3), tetraethylene glycol dimethyl ether (G4), diethylene glycol dibutyl ether, diethylene glycol methyl ethyl ether, triethylene glycol methyl ethyl ether, and triethylene glycol butyl methyl ether.

An additional example of the solvent may be an ionic solution. Examples of the cation of the ionic solution may include a piperidinium skeleton cation, a pyrrolidinium skeleton cation, an imidazolium skeleton cation, an ammonium cation, and a phosphonium cation.

Examples of the anion of the ionic solution may include an amide anion typified by a bis(fluorosulfonyl)amide (FSA) anion and a bis(trifluoromethanesulfonyl)amide (TFSA) anion; a phosphate anion typified by a hexafluorophosphate anion and a tris(pentafluoroethyl)trifluorophosphate anion; a tetrafluoroborate (TFB) anion; and a triflate anion.

3. Other Compounds

The liquid electrolyte in the present disclosure may contain just the cesium fluoride and the solvent, and may further contain an additional compound. Examples of the additional compound may include an alkali metal amide salt.

The alkali metal amide salt usually includes a cation of an alkali metal and an amide anion, The amide anion refers to an anion in which a proton is taken out from the secondary amine (R¹R²NH)

Examples of the alkali metal may include Li, Na, K, Rb, and Cs. Meanwhile, examples of the amide anion may include a sulfonyl amide anion and a silyl amide anion. The sulfonyl amide anion is an anion in which a N (anion center) in an amide anion bonds with a S in a sulfonyl group. The sulfonyl amide anion may include one or two of the sulfonyl group. It is preferable that the sulfonyl group bonds with an aikyl group (such as C4 or less), a fluoroalkyl group (such as C4 or less), or a fluorine. Examples of the sulfonyl amide anion may include a bis(fluorosulfonyl)amide (FSA) anion and a bis(trifluoromethanesulfonyl)amide (TFSA) anion.

The silyl amide anion is an anion in which a N (anion center) in an amide anion bonds with a Si in a silyl group. The silyl amide anion may include one or two of the silyl group. It is preferable that the silyl group bonds with an alkyl group (such as C4 or less), a fluoroalkyl group (such as C4 or less), or a fluorine. Examples of the silyl amide anion may include a bis(trimethylsilyl)amide (TMSA) anion, a bis(trifluoromethlsilyl)amide anion, a bis(trifluorosilyl)amide anion, a bis(triethylsilyl)amide anion, a bis(tert-butyldimethylsilyl)amide anion, and a (trimethylsilyl)trifluoromethylsilyl amide anion. Also, it is preferable that the amide anion is a symmetry amide anion in which two of the functional groups that bond with the N (anion center) are the same.

The concentration of the alkali metal amide salt in the liquid electrolyte is, for example, 0.5 mol/L or more, may be 2.5 mol L or more, and may be 4 mol/L or more. Meanwhile, the concentration of the alkali metal amide salt is, for example, 8 mol/L or less and may be 6 mol/L or less. Also, the molar ratio (B/A) of the cesium fluoride (B) to the alkali metal amide salt (A) is, for example, 0.02 or more, and may be 0.05 or more. Meanwhile, the molar ratio (B/A) is, for example, 1.5 or less, and may be 1 or less. Also, as the solvent, the liquid electrolyte in the present disclosure preferably contains the glyme, and preferably further contains the alkali metal amide salt.

4. Liquide Electrolyte

The amount of moisture in the liquid electrolyte of the present disclosure is in the specific range. The amount of moisture in the liquid electrolyte is usually 50 ppm or more, may be 75 ppm or more, may be 100 ppm or more, and may be 200 ppm or more. Meanwhile, the amount of moisture in the liquid electrolyte is, usually 1100 ppm or less, may be 1000 ppm or less, may be 900 ppm or less, and may be 800 ppm or less. The amount of moisture in the liquid electrolyte may be determined by a Karl Fischer measurement machine.

It is preferable that the concentration of active fluoride ion (active F⁻) in the liquid electrolyte is high. The concentration of active F⁻ at 25° C. is, for example, 1.5 mM or more, may be 20 mM or more, may be 2.5 mM or more, and may be 3.0 mM or more. The reason therefor is such that a fluoride ion battery with excellent capacity properties may be obtained. Meanwhile, the concentration of active F⁻ at 25° C. is, for example, 10 mM or less. Incidentally, M (molar) in the present disclosure is in the same meaning as of mol/L.

Incidentally, in a F(HF)ₓ⁻ anion, it is difficult for F⁻ to be separated from HF. Accordingly, it may be difficult to sufficiently fluoridate an active material in some cases. Incidentally, x is a real number larger than 0, and satisfies, for example, 0<x≤5. Accordingly, it is preferable that the liquid electrolyte substantially does not contain the F(HF)ₓ⁻ anion. The proportion of the F(HF)ₓ⁻ anion to the entire anions present in the liquid electrolyte is, for example, 0.5 mol % or less, may be 0.3 mol % or less, and may be 0 mol %.

There are no particular limitations on the method for producing the liquid electrolyte in the present disclosure; for example, a method described in “C. Method for producing liquid electrolyte” later may be adopted. Also, the liquid electrolyte in the present disclosure is used in a fluoride ion battery. The fluoride ion battery is explained in “B. Fluoride ion battery” in details later.

B. Fluoride Ion Battery

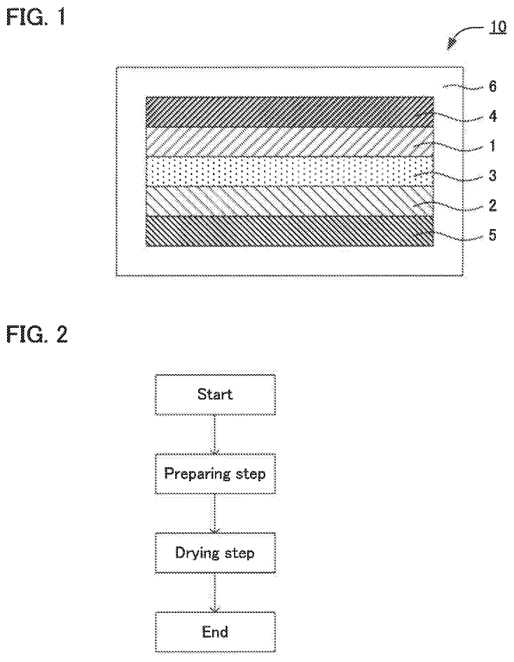

FIG. 1 is a schematic cross-sectional view illustrating an example of the fluoride ion battery in the present disclosure. Fluoride ion battery 10 illustrated in FIG. 1 comprises cathode active material layer 1, anode active material layer 2, electrolyte layer 3 formed between the cathode active material layer 1 and the anode active material layer 2, cathode current collector 4 for collecting currents of cathode active material layer 1, anode current collector 5 for collecting currents of anode active material layer 2, and battery case 6 for storing these members. In the present disclosure, the electrolyte layer 3 contains the above described liquid electrolyte.

According to the present disclosure, usage of the above described liquid electrolyte allows a fluoride ion battery to have, for example, excellent capacity properties.

1. Electrolyte Layer

The electrolyte layer in the present disclosure is a layer formed between the cathode active material layer and the anode active material layer. In the present disclosure, the electrolyte layer contains the above described liquid electrolyte. There are no particular limitations on the thickness of the electrolyte layer.

2. Cathode Active Material Layer

The cathode active material layer in the present disclosure is a layer that contains at least a cathode active material. Also, the cathode active material layer may further contain at least one of a conductive material and a binder, other than the cathode active material.

Examples of the cathode active material in the present disclosure may include a simple substance of metal, an alloy, a metal oxide, and the fluoride of these. Examples of the metal element included in the cathode active material may include Cu, Ag, Ni, Co, Ph, Ce, Mn, Au, Pt, Rh, V, Os, Ru, Fe, Cr, Bi, Nb, Sb, Ti, Sn, and Zn. Among them, it is preferable that the cathode active material is Cu, CuFₓ, Fe, FeFₓ, Ag, and AgFₓ. Incidentally, the “x” is a real number larger than 0. Also, additional examples of the cathode active material may include a carbon material and the fluoride thereof. Examples of the carbon material may include graphite, coke, and carbon nanotube. Also, further additional examples of the cathode active material may include a polymer material. Examples of the polymer material may include polyaniline, polypyrrole, polyacetylene, and polythiophene.

There are no particular limitations on the conductive material as long as it has the desired electron conductivity, and examples thereof may include a carbon material. Examples of the carbon material may include carbon black such as acetylene black, Ketjen black, furnace black, and thermal black; graphene, fullerene, and carbon nanotube. Meanwhile, there are no particular limitations on the binder as long as it is chemically and electronically stable, and examples thereof may include a fluorine-based binder such as polyvinylidene fluoride (PVDF) and polytetra fluoroethylene (PTFE).

Also, the content of the cathode active material in the cathode active material layer is preferably larger from the viewpoint of capacity; for example, the content is 30 weight % or more, preferably 50 weight % or more, and more preferably 70 weight % or more. Also, there are no particular limitations on the thickness of the cathode active material layer.

3. Anode Active Material Layer

The anode active material layer in the present disclosure is a layer that contains at least an anode active material. Also, the anode active material layer may further contain at least one of a conductive material and a binder, other than the anode active material.

Examples of the anode active material in the present disclosure may include a simple substance of metal, an alloy, a metal oxide, and the fluoride of these. Examples of the metal element included in the anode active material may include La, Ca, Al, Eu, Li, Si, Ge, Sn, In, V, Cd, Cr, Fe, Zn, Ga, Ti, Nb, Mn, Yb, Zr, Sm, Ce, Ma, and Pb. Among them, it is preferable that the anode active material is Mg, MgFₓ, Al, AlFₓ, Ce, CeFₓ, Ca, CaCaFₓ, Pb, and PbFₓ. Incidentally, the “x” is a real number larger than 0. Also, as the anode active material, the above described carbon material and polymer material may be used.

As the conductive material and the binder, the same materials as those described in “2. Cathode active material layer” above may be used. Also, the content of the anode active material in the anode active material layer is preferably larger from the viewpoint of capacity; for example, the content is 30 weight % or more, preferably 50 weight % or more, and more preferably 70 weight % or more. Also, there are no particular limitations on the thickness of the anode active material layer

4. Other Constitutions

The fluoride ion battery in the present disclosure comprises at least the above described cathode active material layer, anode active material layer, and electrolyte layer. The battery usually further comprises a cathode current collector for collecting currents of the cathode active material layer, and an anode current collector for collecting currents of the anode active material layer. Examples of the shape of the current collectors may include a foil shape, a mesh shape, and a porous shape. Also, the fluoride ion battery may include a separator between the cathode active material layer and the node active material layer. The reason therefor is to obtain a battery with higher safety.

5. Fluoride Ion Battery

The fluoride ion battery in the present disclosure may be a primary battery and may be a secondary batter, but preferably a secondary battery among them, so as to be repeatedly charged and discharged and useful as a car-mounted battery for example. Also, examples of the shape of the fluoride ion battery in the present disclosure may include a coin shape, a laminate shape, a cylindrical shape, and a square shape.

C. Method for Producing Liquid Electrolyte

FIG. 2 is a flow chart showing an example of the method for producing the liquid electrolyte in the present disclosure. In FIG. 2, first, a precursor solution containing a cesium fluoride and a solvent is prepared (preparing step). Next, a decompression drying treatment to the precursor solution is conducted under an inert atmosphere with a dew point of −90° C. or less to obtain the liquid electrolyte of which amount of moisture is in the specific range (drying step).

In the present disclosure, the decompression drying treatment is conducted in an environment with extremely low dew point and the amount of moisture is adjusted to the specific range so as to obtain a liquid electrolyte in which the concentration of active fluoride ion is high. As described in Comparative Examples later, even when the liquid electrolyte is fabricated in the environment with extremely low dew point, the amount of moisture becomes about 1500 ppm since CsF easily reacts with moisture in the atmosphere. The fabrication of a fluoride ion battery itself is possible using such a liquid electrolyte. In addition thereto, in the present disclosure, the decompression drying treatment is further conducted to thoroughly remove the amount of moisture compared to the conventional methods, and thus the liquid electrolyte in which concentration of active fluoride ion is high, may be obtained.

1. Preparing Step

The preparing step in the present disclosure is a step of preparing a precursor solution containing a cesium fluoride and a solvent.

The precursor solution may contain just the cesium fluoride and the solvent, and may further contain an additional compound. The matters regarding this are in the same contents as those described in “A. Liquid electrolyte” above; thus, the descriptions herein are omitted.

Also, the precursor solution may be prepared by purchasing from others, and may be prepared by fabricating on one's own. In the latter case, the precursor solution may be obtained by conducting a dissolving step of dissolving a cesium fluoride in a solvent. Also, in the dissolving step, a stirring step is preferably conducted as required.

The dew point in the dissolving step is preferably low. The dew point in the dissolving step is, for example, −75° C. or less, may be −85° C. or less, and may be −95° C. or less. Also, the atmosphere in the dissolving step is preferably an inert atmosphere. Examples of the inert atmosphere may include an atmosphere of noble gas such as argon, and a nitrogen atmosphere. The O₂ concentration in the inert atmosphere is, for example, 5 ppm or less, may be 3 ppm or less, may be 1 ppm or less, and may be 0.5 ppm or less.

The amount of moisture in the precursor solution is, for example, 2000 ppm or less, may be 1800 ppm or less, and may be 1600 ppm or less. Meanwhile, the amount of moisture in the precursor solution is preferably lower, but reducing it to, for example, less than 1500 ppm is difficult in a treatment with usual dew point.

2. Drying Step

The drying step in the present disclosure is a step of conducting a decompression drying treatment to the precursor solution under an inert atmosphere with a dew point of −90° C. or less to obtain the liquid electrolyte of which amount of moisture is 50 ppm or more and 1100 ppm or less.

The dew point in the drying step is preferably low; it is usually −90° C. or less, and −95° C. or less. The environment with such an extremely low dew point can be called a special environment, which is different from the environment with general dew point. Also, in order to achieve the environment with dew point of −95° C. or less, there are many restrictions of facilities such as a glove box. Also, examples of the inert atmosphere may include an atmosphere of noble gas such as argon, and a nitrogen atmosphere. The O₂ concentration in the inert atmosphere is, for example, 5 ppm or less, may be 3 ppm or less, may be 1 ppm or less, and may be 0.5 ppm or less.

In the present disclosure, the decompression drying treatment is conducted in an environment with extremely low dew point. The level of decompression may be less than an atmospheric pressure, but is preferably a vacuum. The vacuum may be a low vacuum (100 Pa or more and 50 kPa or less), may be a medium vacuum (0.1 Pa or more and less than 100 Pa), may be a high vacuum (10⁻⁵ Pa or more and less than 0.1 Pa), and may be an ultrahigh vacuum (10⁻⁵ Pa or less).

The treatment time for the decompression drying treatment is, for example, 1.5 minutes or more, may be 3 hours or more, and may be 30 hours or more. Meanwhile, the treatment time for the decompression drying treatment is, for example, 170 hours or less.

3. Liquid Electrolyte

The liquid electrolyte to be obtained by the present disclosure is in the same contents as those described in “A. Liquid electrolyte” above; thus, the descriptions herein are omitted.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

The present disclosure s hereinafter described in more details with reference to Examples. Incidentally, the fabrication of samples and evaluation thereof were conducted in a glove box which was under an Ar atmosphere with a dew point of −95° C. or less and the O₂ concentration of 0.5 ppm or less.

### Examples 1-1 to 1-5 & Comparative Examples 1-1, 1-2

Lithdum bis(fluorosulfonyl)amide (LiFSA from Kishida Chemical Co.,Ltd.) and cesium fluoride (CsF from KANTO CHEMICAL CO., INC.) were weighed so as to be respectively 4.5 M and 0.92 M and mixed with tetraglyme (from Kishida Chemical Co.,Ltd., amount of moisture being 40 ppm or less). The obtained mixture was stirred at 30° C. in a sealed container made of a fluorine resin, and thereby a precursor solution was obtained. After that, the precursor solution was vacuum-dried (20 Pa to 2000 Pa) changing times, and thereby a liquid electrolyte was obtained.

### Comparative Examples 1-3

A liquid electrolyte was obtained in the same manner as in Example 1-1 except that the precursor solution was not vacuum-dried. It means that, the precursor solution was used as the measurement sample.

### Example 2-1 & Comparative Example 2-1

A precursor solution was obtained in the same manner as in Example 1-1 except that the concentration of the cesium fluoride was changed to 0.46 M. After that, the precursor solution was vacuum-dried changing times in the same manner as above and thereby a liquid electrolyte was obtained.

### Example 3-1, 3-2

A precursor solution was obtained in the same manner as in Example 1-1 except that the concentration of the cesium fluoride was changed to 0.62 M. After that, the precursor solution was vacuum-dried changing times in the same manner as above and thereby a liquid electrolyte was obtained.

### Examples 4-1, 4-2 & Comparative Example 4-1

A precursor solution was obtained in the same manner as in Example 1-1 except that the concentration of the cesium fluoride was changed to 1.4 M. After that, the precursor solution was vacuum-dried changing times in the same manner as above and thereby a liquid electrolyte was obtained.

[Evaluation]

<Amount of Moisture Measurement>

The amount of moisture in the liquid electrolyte obtained in each Example and each. Comparative Example was measured. The measurement was conducted using a Karl Fischer measurement machine (from Hiranuma Inc., AQUACOUNTER AQ-2200) and conducted three times or more in order not to have measurement error. Also, when the measurement date was after a day or more from the previous measurement, the Karl Fischer solution was replaced and the measurement accuracy was secured with a comparison material before the measurement, so as to have the same condition as that for the previous time, as much as possible.

<NMR Measurement>A ¹⁹F-MNR measurement was conducted to the liquid electrolyte obtained in each Example and each Comparative Example. The measurement was conducted using a NMR device (from Bruker, AVANCE III 600, 5 mm TCI cryoprobe) in the condition of at 25° C. and the same amount of each sample.

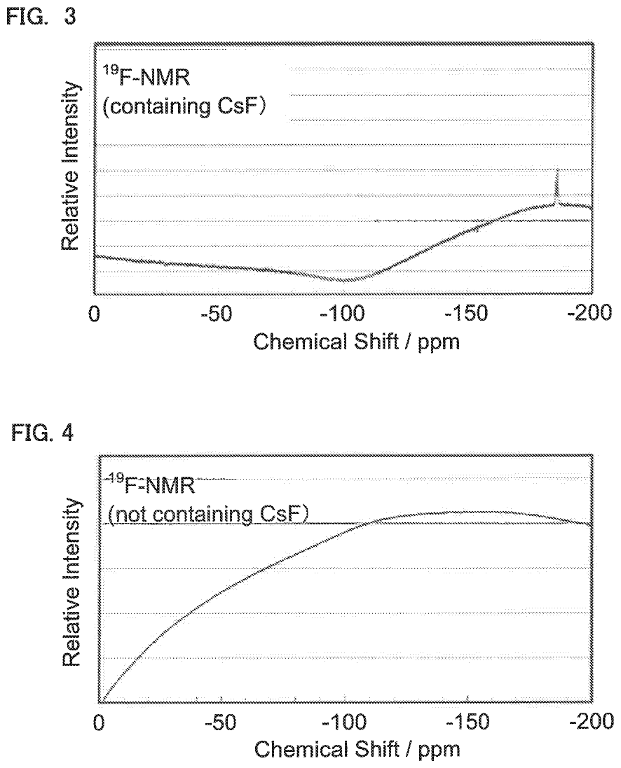

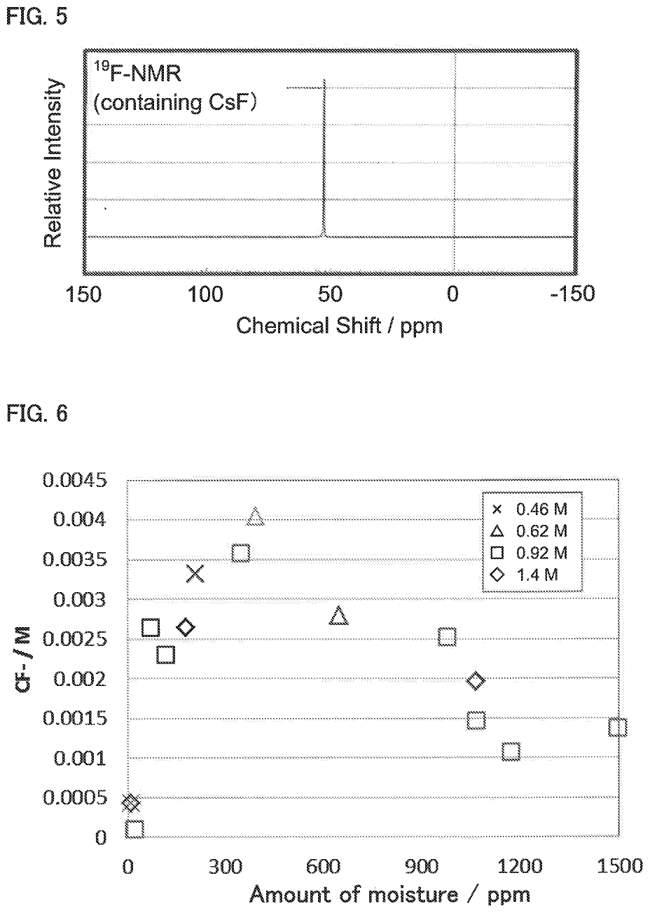

As the representative result, the result of Example 1-3 is shown in FIG. 3. Also, as a reference data, FIG. 4 shows the result of ¹⁹F-MNR measurement for a liquid electrolyte fabricated in the same manner as in Example 1-3 except that the CsF was not used. In FIG. 3, a peak was confirmed in the vicinity of −185 ppm, but this peak was not confirmed in FIG. 4. It was confirmed that this peak was the peak of F⁻ (active F⁻) derived from CsF since it was seen when CsF was present. The result in high ppm side of ¹⁹F-MNR measurement for Example 1-3 is shown in FIG. 5. As shown in FIG. 5, a peak was confirmed in the vicinity of 55 ppm; this is the peak of F⁻ derived from FSA. Further, as shown in FIG. 3 and FIG. 4, in the liquid electrolyte obtained in Example 1-3, just the peaks derived from CsF and FSA were confirmed but the peak derived from impurities such as a decomposition product and a hydrofluoric acid was not confirmed.

Also, the concentration of active fluoride ion. (active F⁻) was determined as follows: the integrated value (area) of FSA signal (signal having a peak in the vicinity of 55 ppm) and the integrated value (area) of CsF derived F⁻ (active F⁻) signal (signal having a peak in the vicinity of −185 ppm) were calculated; the ratio of these integrated values were obtained; the ratio was multiplied by a FSA concentration. (known concentration) to obtain the concentration of active F⁻:

Concentration of active F⁻=FSA concentration (M)*(integrated value of active F⁻)/{(integrated value of FSA)/2}.

The results are shown in Table 1 and FIG. 6.

TABLE 1

| | CsF | | |
|---|---|---|---|
| | concentration | Amount of | |
| | (M) | moisture (ppm) | CF− (M) |
| Comparative Example 1-1 | 0.92 | 20 | 0.00011 |
| Example 1-1 | | 72 | 0.0026 |
| Example 1-2 | | 118 | 0.0023 |
| Example 1-3 | | 350 | 0.0036 |
| Example 1-4 | | 979 | 0.0025 |
| Example 1-5 | | 1070 | 0.0015 |
| Comparative Example 1-2 | | 1180 | 0.0011 |
| Comparative Example 1-3 | | 1500 | 0.0014 |
| Comparative Example 2-1 | 0.46 | 12 | 0.00043 |
| Example 2-1 | | 210 | 0.0033 |
| Example 3-1 | 0.62 | 398 | 0.004 |
| Example 3-2 | | 648 | 0.0028 |
| Comparative Example 4-1 | 1.4 | 12 | 0.00043 |
| Example 4-1 | | 182 | 0.0026 |
| Example 4-2 | | 1070 | 0.002 |

As shown in Table 1 and FIG. 6, when the amount of moisture exceeded 1100 ppm, the concentration of active fluoride ion was low. This was presumably because the fluoride ion (F⁻) was deactivated due to the moisture. On the other hand, the concentration of active fluoride ion was also low when the amount of moisture was less than 50 ppm. This was presumably because the fluoride ion (F⁻) was unstable and not easily separated from CsF. Alternatively, the possibility of remarkable volatilization of fluoride ion (F⁻) can also be considered. Meanwhile, it was confirmed that the concentration of active fluoride ion was high when the amount of moisture was in the specific range.

### REFERENCE SIGNS LIST

1 cathode active material layer
2 anode active material layer
3 electrolyte layer
4 cathode current collector
5 anode current collector
6 battery case
10 fluoride ion battery

What is claimed is:

1. A liquid electrolyte to be used in a fluoride ion battery, the liquid electrolyte comprising:
a cesium fluoride and a solvent; and
an amount of moisture is 50 ppm or more and 1100 ppm or less.

2. The liquid electrolyte according to claim 1, wherein the amount of moisture is 50 ppm or more and 900 ppm or less.

3. The liquid electrolyte according to claim 1, wherein concentration of active fluoride ion at 25° C. is 2.0 mM or more.

4. The liquid electrolyte according to claim 1, further comprising an alkali metal amide salt.

5. The liquid electrolyte according to claim 1, wherein a glyme is included as the solvent.

6. A fluoride ion battery comprising a cathode active material layer, an anode active material layer, and an electrolyte layer formed between the cathode active material layer and the anode active material layer; wherein
the electrolyte layer contains the liquid electrolyte according to claim 1.

7. A method for producing a liquid electrolyte to be used in a fluoride ion battery, the method comprising:
a preparing step of preparing a precursor solution containing a cesium fluoride and a solvent; and
a drying step of conducting a decompression drying treatment to the precursor solution under an inert atmosphere with a dew point of −90° C. or less to obtain the liquid electrolyte of which amount of moisture is 50 ppm or more and 1100 ppm or less.
